(19) United States
(12) Patent Application Publication
(10) Pub. No.: US 2026/0175537 A1
(43) Pub. Date: Jun. 25, 2026

(54) COLOR-TUNABLE PIGMENT MEDIUM

(71) Applicant: VIAVI Solutions Inc., Chandler, AZ (US)

(72) Inventors: Vladimir P. RAKSHA, Santa Rosa, CA (US); Paul T. KOHLMANN, Windsor, CA (US); Kees-Jan DELST, Fairfax, CA (US)

(21) Appl. No.: 19/416,671

(22) Filed: Dec. 11, 2025

Related U.S. Application Data
(60) Provisional application No. 63/738,143, filed on Dec. 23, 2024.

(51) Int. Cl. B32B 15/20; B32B 18/00

(52) U.S. Cl. CPC B32B 15/20; B32B 18/00; B32B 2250/05; B32B 2250/40; B32B 2307/30; B32B 2307/402

(57) ABSTRACT

A color-tunable pigment medium includes an optical stack of thin-film layers. The optical stack of thin-film layers includes one or more transition metal oxide layers of one or more transition metal oxides; and one or more metal layers of at least one of aluminum or chromium. Each transition metal oxide layer of the one or more transition metal oxide layers is arranged directly adjacent to at least one metal layer of the one or more metal layers. The layer stack has, in a pre-elevated temperature state, a first color. The layer stack has, in an elevated temperature state, a second color different from the first color.

### CROSS-REFERENCE TO RELATED APPLICATION

This Patent Application claims priority to U.S. Provisional Patent Application No. 63/738,143, filed on Dec. 23, 2024, and entitled “COLOR-TUNABLE INTERFERENCE PIGMENT.” The disclosure of the prior Application is considered part of and is incorporated by reference into this Patent Application.

### BACKGROUND

Thermochromism is the change in the color of organic or inorganic compounds when heated or cooled. Generally, chromism is a process that induces a change, often reversible, in the colors of compounds. In most cases, chromism is based on a change in the electron states of molecules. The phenomenon is induced by various external stimuli that can alter the electron density of substances or cause a change in the crystalline phase, ligand geometry, or other factors.

Thermochromic materials can be organic or inorganic. Organic materials are primarily liquid crystals or leuco dyes. Inorganic materials are cuprous mercury iodide (Cu₂[HgI₄]), silver mercury iodide (Ag₂[HgI₄]), mercury(II) iodide, HgCl₂, oxides of chromium, bismuth, vanadium iron, indium, tungsten, niobium, molybdenum, europium, and others.

### SUMMARY

In some implementations, a color-tunable pigment medium, comprising an optical stack of thin-film layers comprising: one or more transition metal oxide layers of one or more transition metal oxides; and one or more metal layers of at least one of aluminum or chromium, wherein each transition metal oxide layer of the one or more transition metal oxide layers is arranged directly adjacent to at least one metal layer of the one or more metal layers, wherein the layer stack has, in a pre-elevated temperature state, a first color, and wherein the layer stack has, in an elevated temperature state, a second color different from the first color.

In some implementations, a color-tunable interference pigment medium, comprising an optical stack of thin-film layers comprising: one or more transition metal oxide layers of one or more transition metal oxides; and one or more metal layers of at least one of aluminum or chromium, wherein each transition metal oxide layer of the one or more transition metal oxide layers is arranged directly adjacent to at least one metal layer of the one or more metal layers, wherein the layer stack, in a pre-elevated temperature state, has an obscured hue, and wherein the layer stack has, in an elevated temperature state, a visible hue different than the obscured hue.

In some implementations, a method includes providing a pigment medium comprising an optical stack of thin-film layers, the optical stack of thin-film layers including one or more transition metal oxide layers and one or more metal layers, each metal layer of the one or more metal layers comprises at least one of aluminum or chromium, and each transition metal oxide layer of the one or more transition metal oxide layers being arranged directly adjacent to at least one metal layer of the one or more metal layers; applying an elevated heat to the pigment medium to induce a color transition of the pigment medium; monitoring the color transition of the pigment medium while applying the elevated heat; continuing to apply the elevated heat until a desired color is achieved in the pigment medium; and stopping the application of the elevated heat to the pigment medium upon achieving the desired color.

### BRIEF DESCRIPTION OF THE DRAWINGS

FIG. 1 shows a color-tunable pigment medium according to one or more implementations.

FIG. 2 shows a graph showing two reflectance curves over wavelength of a color-tunable pigment medium according to one or more implementations.

FIG. 3 shows a graph showing two reflectance curves over wavelength of a color-tunable pigment medium according to one or more implementations.

FIG. 4 shows a graph showing two reflectance curves over wavelength of a color-tunable pigment medium according to one or more implementations.

FIG. 5 shows a graph showing two reflectance curves over wavelength of a color-tunable pigment medium according to one or more implementations.

FIG. 6 shows a color-tunable pigment medium according to one or more implementations.

FIG. 7 shows goniochromatic color changes in a CIELab color space for the color-tunable pigment medium.

FIG. 8 is a flowchart of an example process associated with a color-tunable pigment medium.

### DETAILED DESCRIPTION

The following detailed description of example implementations refers to the accompanying drawings. The same reference numbers in different drawings may identify the same or similar elements.

Interference pigments and thermochromic materials are widely used in applications such as security printing, document authentication, and decorative coatings. These materials can exhibit color changes in response to external stimuli, such as temperature, light, or electric fields. Traditional thermochromic pigments generally rely on reversible changes in molecular electron states or crystalline phase transitions to produce color shifts.

However, existing thermochromic systems often require high activation temperatures, may not provide precise or irreversible color changes, and can suffer from limited durability or stability when incorporated into printed security features on documents or other substrates. Furthermore, achieving controlled, tunable, and irreversible color transitions at moderate temperatures suitable for common substrates such as paper remains a significant technical challenge. Conventional approaches may also lack the ability to finely adjust pigment color or to produce distinct, stable color regions for advanced optical security elements, limiting their effectiveness in anti-counterfeiting and authentication technologies.

Some implementations described herein provide a pigment medium with a multilayer structure, in which one or more layers of a transition metal oxide are arranged in direct contact with one or more metal layers composed of aluminum or chromium. The transition metal oxide may be an oxide of tungsten, molybdenum, europium, indium, vanadium, niobium, titanium, bismuth, or iron. In some implementations, the multilayer structure may have layers of two or more different transition metal oxides, with each transition metal oxide being arranged in direct contact with one or more aluminum layers and/or chromium layers.

Upon application of elevated heat, a chemical redox reaction occurs between the transition metal oxide and the adjacent metal layers, leading to an irreversible color change of the pigment. The color transition can be precisely controlled by monitoring the pigment color during heating and stopping the process once the desired color is achieved. For example, the color transition can be controlled based on controlling the temperature and/or duration of the heat application. In addition, the color of the pigment medium may also depend on the thickness of one or more layers of the transition metal oxide. The pigment medium is capable of transitioning from an initial hue (which may be obscured or colorless) to a stable and visible hue suitable for security and decorative applications. The applied heat may be controlled to be between 100 degrees Celsius and 350 degrees Celsius, which is suitably low for paper-based printing applications without causing paper-based substrates to ignite.

In this way, the pigment medium enables controlled, tunable, and irreversible color changes at moderate temperatures compatible with substrates such as paper, overcoming the limitations of conventional thermochromic systems that require high activation temperatures or that provide reversible and less stable color transitions. By facilitating irreversible color changes at moderate temperatures, the pigment medium may reduce the energy required during manufacturing or printing processes and may allow integration with temperature-sensitive substrates. Additionally, the multilayer structure of the pigment medium may provide enhanced chemical and thermal stability, resulting in improved resistance to environmental degradation and reduced need for additional protective coatings. In this way, the pigment medium may conserve energy resources, material resources, processing resources, and/or the like.

As used herein, the term ‘color’ refers to a perceptible chromatic value observable by the human eye or measured by a colorimetric instrument, such as a spectrophotometer, under standard viewing conditions (e.g., D65 illumination, observer angle as specified in CIE standards). ‘First color’ and ‘second color’ denote distinct measurable states with respect to spectral reflectance or transmission, where the colorimetric values (e.g., CIELab coordinates or peak reflectance wavelength) differ by at least a detectable threshold, such as a delta E of 5 or greater. An ‘obscured hue’ may refer to a state in which the pigment medium is substantially colorless or visually indistinct under standard lighting and observation conditions, corresponding to a CIELab chroma value less than 3. A ‘visible hue’ may refer to a state wherein the pigment medium exhibits a chromatic value with a CIELab chroma greater than 10, or is otherwise visually distinct from the obscured hue. The term ‘desired color’ refers to a colorimetric value preselected by the operator or user, as measured by a colorimetric device or visually identified by reference to a color chart, and is reached when the pigment medium matches or closely approximates the preselected value within industry-accepted tolerances (e.g., delta E less than 3). Furthermore, as used herein, the term “goniochromatic” refers to a property of materials or pigments in which the observed color changes depending on the angle at which the material is viewed. In the context of interference pigments, goniochromatic color changes result from variations in reflected or transmitted light due to the structure and composition of the multilayer pigment medium, such that the color appears to shift when the observation angle varies.

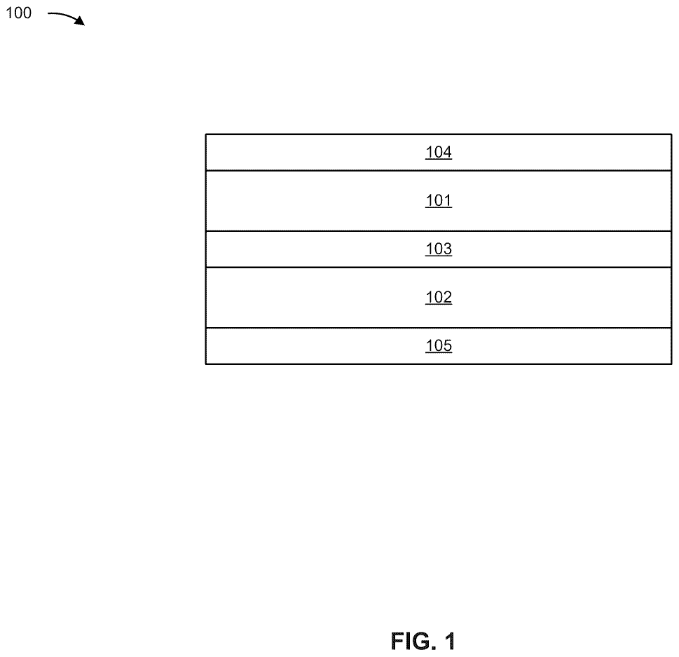

FIG. 1 shows a color-tunable pigment medium 100 according to one or more implementations. The color-tunable pigment medium 100 may be an irreversible thermochromic-effect pigment medium. The color-tunable pigment medium 100 may have a thin-film design, with a plurality of layers 101-105 arranged in a layer stack (e.g., an optical stack of thin-film layers). While five layers are shown, the color-tunable pigment medium 100 may have a fewer or a greater number of layers. The layer stack may include one or more transition metal oxide layers of one or more transition metal oxides. For example, layers 101 and 102 may be transition metal oxide layers. In other words, layer 101 may be a first transition metal oxide layer and layer 102 may be a second transition metal oxide layer. In addition, the layer stack may include one or more metal layers of at least one of aluminum or chromium. For example, layers 103, 104, and 105 may be metal layers of aluminum or chromium. In other words, layer 103 may be a first metal layer of aluminum or chromium, layer 104 may be a second metal layer of aluminum or chromium, and layer 105 may be a third metal layer of aluminum or chromium. In some implementations, the metal layers 103, 104, and 105 may be the same metal material (e.g., all metal layers may be aluminum or all metal layers may be chromium). In some implementations, the layer stack may include both aluminum and chromium. For example, metal layer 103 may be aluminum and metal layers 104 and 105 may be chromium. Accordingly, each transition metal oxide layer of the one or more transition metal oxide layers is arranged directly adjacent to at least one metal layer of the one or more metal layers.

In some implementations, the layer stack has, in a pre-elevated temperature state, a first color, and has, in an elevated temperature state, a second color different from the first color. In other words, an external heat may be applied to the layer stack to trigger or otherwise induce a color change of the layer stack, thereby causing the color-tunable pigment medium 100 to change colors. For example, each transition metal oxide layer of one or more transition metal oxide layers may, in response to an applied external heat, transform into a respective chemically-reduced transition metal oxide as a result of its direct contact with an adjacent metal layer. The application of the applied external heat may be controlled between 100 degrees Celsius and 350 degrees Celsius. Moreover, the color change from the first color to the second color is irreversible.

To obtain the color change of the color-tunable pigment medium 100, each transition metal oxide layer has, in the pre-elevated temperature state, a first respective color, and has, in the elevated temperature state, a second respective color different from the first respective color. The respective colors of the transition metal oxide layers contribute to the overall color of the color-tunable pigment medium 100. In particular, each transition metal oxide layer is configured to, based on an elevated temperature being applied, undergoes a respective chemical redox reaction with at least one metal layer that is arranged directly adjacent to the transition metal oxide layer. The respective chemical redox reaction causes the transition metal oxide layer to undergo a color change. The respective chemical redox reaction changes stoichiometry of the transition metal oxide layer that causes change to its color.

In some implementations, each transition metal oxide layer includes tungsten, molybdenum, europium, indium, vanadium, niobium, titanium, bismuth, or iron. The layer stack may include a single transition metal oxide such that all transition metal oxide layers in the layer stack are the same material and may have the same material composition. In some implementations, the layer stack may include a multiple different transition metal oxides such that some transition metal oxide layers are made of different materials.

In some implementations, the one or more transition metal oxide layers include a first layer of tungsten trioxide (e.g., layer 101) and a second layer of tungsten trioxide (e.g., layer 102), and the one or more metal layers include an aluminum layer (e.g., layer 103), a first chromium layer (e.g., layer 104), and a second chromium layer (e.g., layer 105). The aluminum layer may be arranged between, and in direct contact with, the first layer of tungsten trioxide and the second layer of tungsten trioxide. The first layer of tungsten trioxide may be arranged between, and in direct contact with, the aluminum layer and the first chromium layer. The second layer of tungsten trioxide may be arranged between, and in direct contact with, the aluminum layer and the second chromium layer. Other transition metal oxide layers may be used in place of tungsten trioxide, depending on the desired first color and the desired second color.

In some implementations, the one or more transition metal oxide layers include a first layer of tungsten trioxide (e.g., layer 101) and a second layer of tungsten trioxide (e.g., layer 102), and the one or more metal layers include a first chromium layer (e.g., layer 103), a second chromium layer (e.g., layer 104), and a third chromium layer (e.g., layer 105). The first layer of tungsten trioxide may be arranged between, and in direct contact with, the first chromium layer and the second chromium layer. The second layer of tungsten trioxide may be arranged between, and in direct contact with, the first chromium layer and the third chromium layer. Other transition metal oxide layers may be used in place of tungsten trioxide, depending on the desired first color and the desired second color.

In some implementations, the one or more transition metal oxide layers include a first layer of tungsten trioxide (e.g., layer 101) and a second layer of tungsten trioxide (e.g., layer 102), and the one or more metal layers include a first aluminum layer (e.g., layer 103), a second aluminum layer (e.g., layer 104), and a third aluminum layer (e.g., layer 105). The first layer of tungsten trioxide may be arranged between, and in direct contact with, the first aluminum layer and the second aluminum layer. The second layer of tungsten trioxide may be arranged between, and in direct contact with, the first aluminum layer and the third aluminum layer. Other transition metal oxide layers may be used in place of tungsten trioxide, depending on the desired first color and the desired second color.

In some implementations, the color-tunable pigment medium 100 is a color-tunable interference pigment medium that may start out with an obscured hue. For example, the color-tunable interference pigment medium may initially be colorless, transparent, clear, or otherwise not readily visible. Thus, the color-tunable interference pigment medium interferes with perceiving the color-tunable pigment medium 100 on a printed substrate. In this case, the color-tunable pigment medium 100 may be used in security documents. The color-tunable pigment medium 100 may have a layer stack that, in a pre-elevated temperature state, has an obscured hue, and has, in an elevated temperature state, a visible hue different than the obscured hue. In other words, the color-tunable pigment medium 100 may transition, irreversibly, to a perceivable hue based on the application of external heat to the color-tunable pigment medium 100.

Each transition metal oxide layer of the layer stack is configured to, in response to an applied external heat, transform into a respective chemically-reduced transition metal oxide based on a respective chemical redox reaction with the at least one metal layer that is arranged directly adjacent to the transition metal oxide layer.

For the color-tunable interference pigment medium, each transition metal oxide layer of the layer stack has, in the pre-elevated temperature state, a respective obscured hue, thereby making the color-tunable pigment medium 100 not readily visible. Accordingly, each transition metal oxide layer may include tungsten, molybdenum, europium, indium, vanadium, niobium, titanium, or bismuth. Iron oxide cannot be used as a colorless transition metal oxide, since it is readily perceivable (e.g., it is not colorless). In addition, each transition metal oxide layer of the one or more transition metal oxide layers has, in the elevated temperature state, a respective visible hue different from the respective obscured hue. For example, each transition metal oxide layer of the layer stack may, based on an elevated temperature being applied, undergo a respective chemical redox reaction with at least one metal layer that is arranged directly adjacent to the transition metal oxide layer. In other words, respective chemical redox reaction changes stoichiometry of the transition metal oxide layer that causes change to its color. As a result of the direct contact to the adjacent metal layer(s) and the applied external heat, the respective chemical redox reaction causes the transition metal oxide layer to undergo a color change. The respective colors of the transition metal oxide layers contribute to the overall color of the color-tunable interference pigment medium.

Using tungsten trioxide as an example, the main structural element in a WO₃ crystal lattice is an oxygen octahedron WO⁶ with a W⁶⁺ ion at the center. It was found that Fabre type (e.g., F-type) color centers include W⁵⁺ (and possibly W⁴⁺) ions, the concentration of which grows in a film such as tungsten trioxide (WO₃) upon vacuum annealing due to oxygen leaving a surface layer of the tungsten trioxide film. It then can be assumed that an absorption band results from electron intervalence transfer represented by reaction (1).

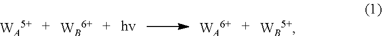

where A and B are closely spaced tungsten ions and hv is the photon energy. Accordingly, a new crystalline phase rapidly growing with temperature should be classified as oxygen-deficient phase WO₃₋ₓ, which has a hexagonal structure. Vacuum annealing at 350° Celsius (C) considerably changes a colorless tungsten trioxide film to a blue WO₃₋ₓ film. The value of x, where 0<x<1, dictates the color change.

Some implementations described herein are directed to a color-tunable interference pigment. The color-tunable interference pigment may be used as color-tunable magnetizable security pigment that changes color irreversibly in response to applied external heat. For example, the color-tunable interference pigment may be applied to paper or other substrate with a printing means. The color-tunable interference pigment may be heated to induce a color change to reveal security text or other printed optical security elements.

It was found that thin films of transition metal oxides, coupled with metal layers of aluminum and/or chromium, irreversibly change their color at elevated temperatures due to a chemical redox reaction between the transition metal oxide and an aluminum layer or a chromium layer. Temperature-sensitive pigments may be used to fabricate printed optical security elements with an obscured or invisible hue. The optical security elements may be selectively heated by scanning a laser on the optical security elements according to a predetermined pattern and/or by hot stamping the optical security elements. The selective heating irreversibly changes a color pattern of the optical security elements.

Thus, a heat-sensitive effect pigment has been developed that irreversibly changes color upon heating to temperatures between 100-350° C. The color change occurs due to chemical redox reactions between transition metal oxide films, such as tungsten trioxide films, and select metals, arranged directly adjacent to the transition metal oxide films. The select metals, such as aluminum and chromium, act as reducing agents. Color-shifting thermochromic pigments may be useful for printing optical security elements on documents (e.g., paper documents) of security value. Selective heating of a predetermined region of a printed color-shifting optical security element (e.g., color-shifting print) would change the color of the predetermined region within the optical security element such that the optical security element has two regions with different colors. In other words, the document containing the optical security element would have two regions of print with different colors. However, heating the document to 650° C. (or in some cases to temperatures higher than 350° C.) may ignite the document. Thus, higher temperatures above 350° C. should not be used for documents.

By placing a WO₃ thin film in contact with a reducing agent metal, the color of the tungsten trioxide changes when heating is applied. Aluminum and chromium may be used as reducing agents. Thin metal films of aluminum and chromium react with tungsten trioxide at elevated temperatures and oxidize at interfaces between the metal films (e.g., aluminum and chromium) and WO₃. A standard reduction potential E° (V) of aluminum and chromium in an aqueous solution at 25° C. is −1.66V and −0.74V, respectively. Tungsten trioxide is reduced by a loss of oxygen ions by the metals of the metal films. The WO₃₋ₓ (0<x<1) phase undergoes structural transformations during reduction, affecting the tungsten trioxide's physical and chemical properties, such as stoichiometry, structure, electrical conductivity, etc. Along these physical and chemical properties, the color of tungsten trioxide changes based on a chemical reduction of the tungsten trioxide.

Stoichiometric WO₃ is colorless, while non-stoichiometric WO₃₋ₓ has different shades of blue depending on the value of the “x.” A tungsten trioxide film that is embedded between two aluminum layers or two chromium layers, and exposed to an elevated temperature, undergoes a color change due to reactions between the metal layers adjacent to the tungsten trioxide film. The following chemical equations (2) and (3) describe the reactions of tungsten trioxide with aluminum and chromium, respectively.

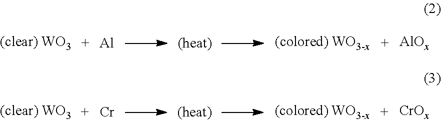

To evaluate the relationship between the redox reaction model of tungsten trioxide with the color change in a WO₃ pigment, two metallic-like low-shifting pigment compositions were fabricated, and the colors of the two coating compositions were analyzed. The structures of the two coating compositions are described in expressions (4) and (5).

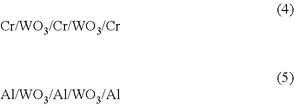

The two pigment coating compositions described in expressions (4) and (5) included two tungsten trioxide spacers (spacer layers) coated with a single film of reducing agent on each surface of WO₃. Chromium films were used as a reducing agent in composition (4), and aluminum films were used as a reducing agent in composition (5). Here, “/” represents a direct interface between adjacent layers of the layer stack. Coated structures were stripped off a substrate and processed into two pigments. Each pigment was divided into two equal portions. One portion was left as a reference material. The other portion was inserted into a tube furnace and heated to 300° C. in air. Both portions of each composition may be mixed later with an organic binder and coated on paper.

In some implementations, the layer stack may have a Fabry-Perot design used for interference pigments. For example, an aluminum absorber (e.g., layer 103) may be arranged as a middle layer of the layer stack, with WO₃ spacer layers (e.g., layers 101 and 102) arranged on opposite sides of the aluminum absorber. The WO₃ spacer layers are in contact with the aluminum absorber. Semi-transparent chromium absorber layers (e.g., layers 104 and 105) may be arranged as bottom and top layers of the layer structure. A bottom semi-transparent chromium absorber layer (e.g., layer 104) is arranged in contact with one of the WO₃ spacer layers, and a top semi-transparent chromium absorber layer (e.g., layer 105) is arranged in contact with the other WO₃ spacer layer. The thickness of the tungsten trioxide spacer layers governs the color of the interference pigment.

As indicated above, FIG. 1 is provided as an example. Other examples may differ from what is described with regard to FIG. 1.

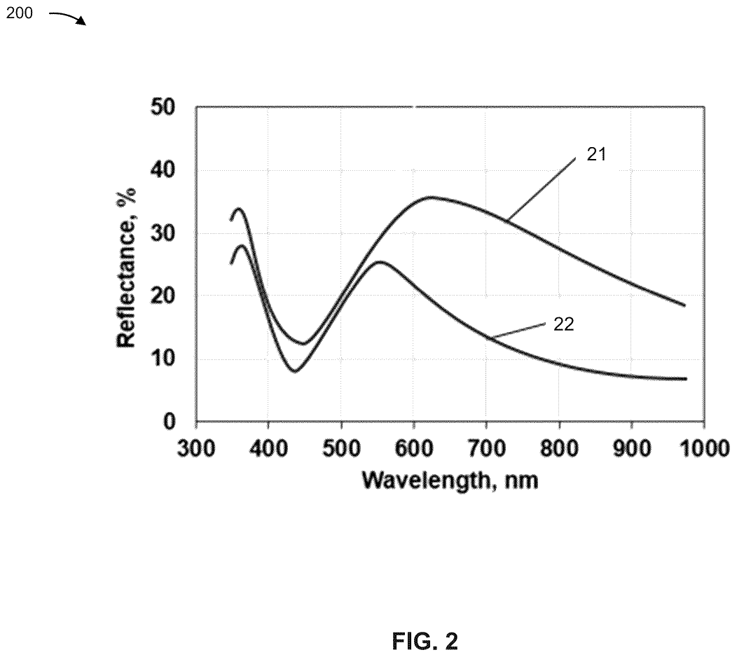

FIG. 2 shows a graph 200 showing two reflectance curves over the wavelength of a color-tunable pigment medium according to one or more implementations. The graph 200 includes reflectance curves 21 and 22 corresponding to a thin-film structure that may be used as a color-tunable pigment medium. Reflectance curve 21 corresponds to the thin-film structure prior to heating, and reflectance curve 22 corresponds to the thin-film structure after heating. The metal layers of the thin-film structure are made from chromium. Accordingly, a layer structure of the thin-film structure includes Cr 12 nm/WO₃ 150 nm/Cr 100 nm/WO₃ 150 nm/Cr 12 nm arranged as a layer stack (e.g., a five-layer pigment medium). “Pre-heated” means post-fabricated pigment in a condition prior to applying a high-temperature treatment that causes a change of color to the post-fabricated pigment. The color of the pre-heated thin-film structure was gold at a normal observation angle, with a reflectance peak at 640 nm on reflectance curve 21. The gold color of the pre-heated thin-film structure changes to green after the pre-heated thin-film structure was heated, in air, to 300° C. In other words, after being in an elevated temperature state, the color of the thin-film pigment structure changes from gold to green. As a result, the reflectance peak of the thin-film pigment structure shifts from 640 nm on curve 21 (gold color) to 560 nm on reflectance curve 22 (green color).

Thermally activated color change of pigment mediums with chromium layers as the reducing agents proves the mechanism of the redox reaction represented by chemical equation (3).

As indicated above, FIG. 2 is provided as an example. Other examples may differ from what is described with regard to FIG. 2.

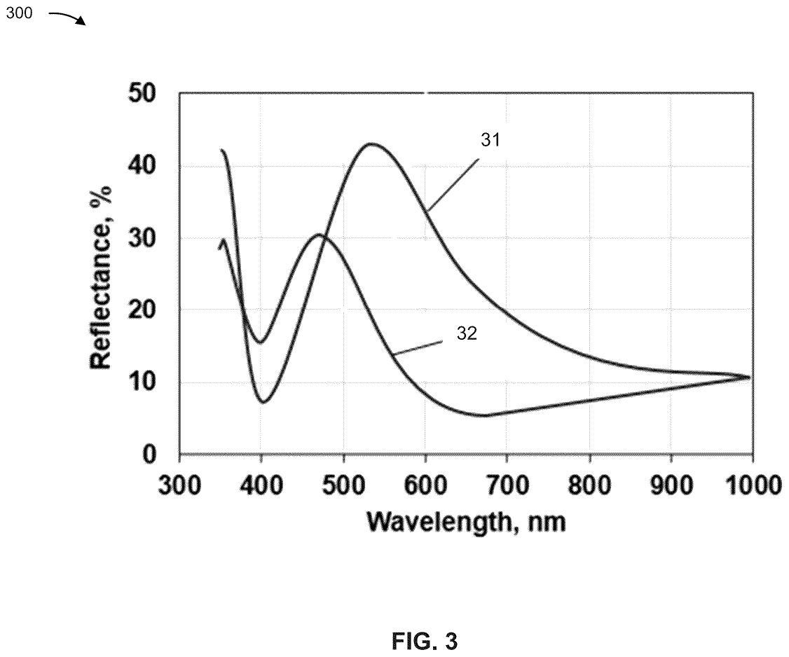

FIG. 3 shows a graph 300 demonstrating reflectance curves of a color-tunable pigment medium according to one or more implementations. Reflectance curve 31 corresponds to a thin-film pigment structure before heating, and reflectance curve 32 corresponds to the thin-film pigment structure after heating. Accordingly, a layer structure of the thin-film structure includes Al 20 nm/WO₃ 150 nm/Al 100 nm/WO₃ 150 nm/Al 20 nm arranged as a layer stack (e.g., a five-layer pigment medium). As indicated by reflectance curve 31, the color of the pre-heated thin-film structure, associated with a reflectance peak of reflectance curve 31, is green, with a maximum on the reflectance curve 31 occurring at 540 nm. The green color of the thin-film structure changes to blue after the thin-film pigment structure is heated, in air, to 300° C. In other words, after being in an elevated temperature state, the color of the thin-film pigment structure changes from green to blue. Responsive to the applied external heat, the reflectance peak of the thin-film structure shifted to 460 nm on reflectance curve 32 as a result of the tungsten trioxide layers being chemically reduced by a chemical redox reaction with their adjacent aluminum layers.

Thermally activated color change of pigment mediums with aluminum layers as the reducing agents proves the mechanism of the redox reaction represented by chemical equation (2).

It is also noted that employment of inert metals, such as platinum or gold, in direct contact with the transition metal oxide layers did not produce a noticeable color change after exposure to an applied external heat. Similarly, having another material, such as silicon dioxide, serving as a barrier for ionic transport and arranged between a transition metal oxide layer and the aluminum or chromium layer also did not produce a noticeable color change when exposed to an applied external heat.

As indicated above, FIG. 3 is provided as an example. Other examples may differ from what is described with regard to FIG. 3.

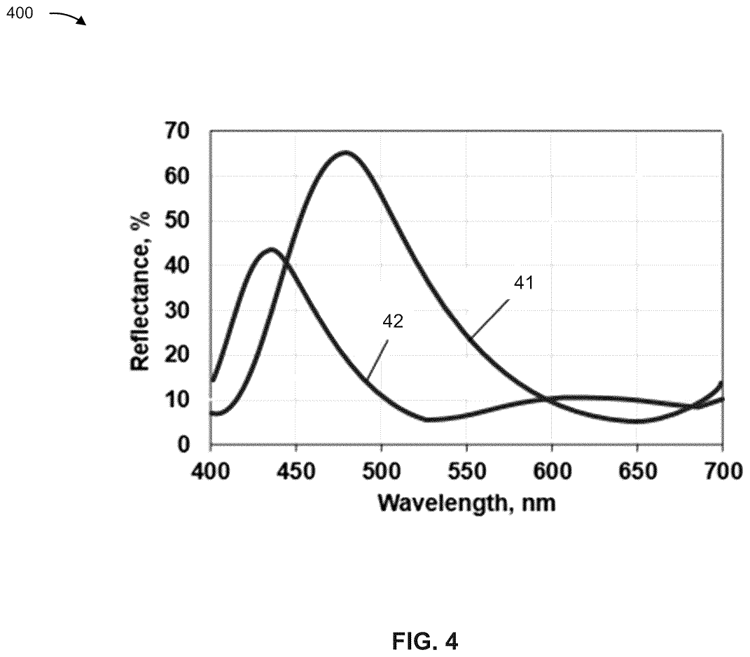

FIG. 4 shows a graph 400 showing two reflectance curves over wavelength of a color-tunable pigment medium according to one or more implementations. The graph 400 includes reflectance curves 41 and 42 corresponding to a thin-film structure that may be used as a color-tunable pigment medium. Reflectance curve 41 corresponds to the thin-film structure prior to heating, and reflectance curve 42 corresponds to the thin-film structure after heating. Accordingly, a layer structure of the thin-film structure includes Cr 12 nm/WO₃ 240 nm/Al 80 nm/WO₃ 240 nm/Cr 12 nm arranged in a layer stack. The thin-film structure is a low-shifting pigment with 240 nm thick layers of WO₃. As indicated by reflectance curve 41, the color of the pre-heated thin-film structure, associated with a reflectance peak of reflectance curve 41, is cyan at a normal observation angle. The cyan color of the thin-film structure changes to purple after the thin-film structure is heated, in air, for a few seconds at 275° C. In other words, after being in an elevated temperature state, the color of the thin-film structure changes from cyan to purple. Responsive to the applied external heat, the reflectance peak of the thin-film structure shifts from about 480 nm on reflectance curve 41 to about 440 nm on reflectance curve 42 as a result of the tungsten trioxide layers being chemically reduced by a chemical redox reaction with their adjacent chromium layers.

As indicated above, FIG. 4 is provided as an example. Other examples may differ from what is described with regard to FIG. 4.

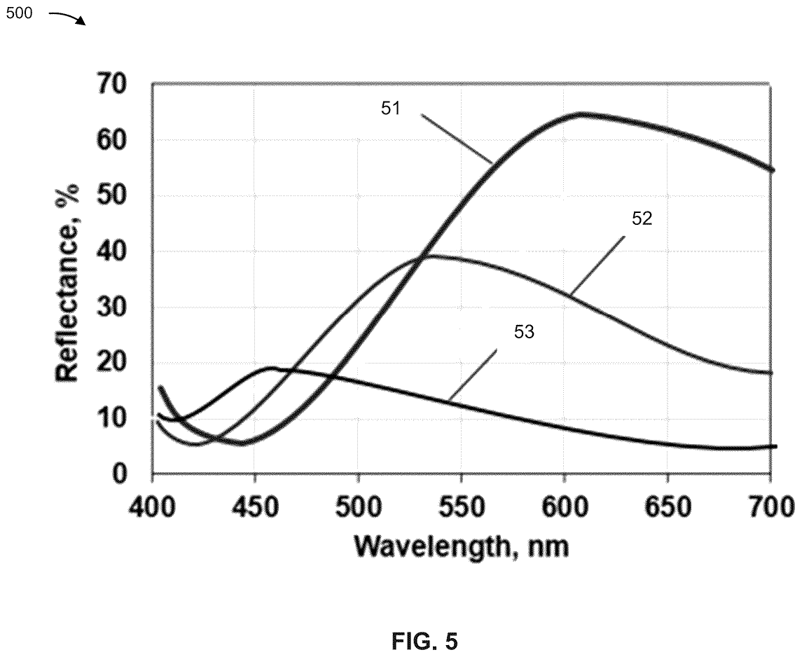

FIG. 5 shows a graph 500 showing two reflectance curves over wavelength of a color-tunable pigment medium according to one or more implementations. The graph 500 includes reflectance curves 51, 52, and 53 corresponding to a thin-film pigment structure that may be used as a color-tunable pigment medium. Reflectance curve 51 corresponds to the thin-film structure prior to heating, reflectance curve 52 corresponds to the thin-film structure after a first heating stage, and reflectance curve 53 corresponds to the thin-film structure after a second heating stage that follows the first heating stage. Accordingly, a layer structure of the thin-film pigment structure includes Cr 6 nm/WO₃ 150 nm/Al 80 nm/WO₃ 150 nm/Cr 6 nm arranged in a layer stack. Thus, the thin-film structure has thinner layers of tungsten trioxide when compared to the thin-film structure described in connection with FIG. 4.

As indicated by reflectance curve 51, the color of the pre-heated thin-film structure, associated with a reflectance peak of reflectance curve 51, is gold at a normal observation angle. The reflectance peak of reflectance curve 51 is at approximately 620 nm. During the first heating stage, the thin-film structure may be heated for a few seconds to 275° C. Responsive to the first heating stage, the gold color of the thin-film structure changes to green. For example, the maximum reflectance peak that occurs on the reflectance curve 51 at 620 nm may shift to 540 nm on the reflectance curve 52 based on the external heat applied during the first heating stage.

Thus, the color of the thin-film structure becomes green as a result of the first heating stage. Further heating of the thin-film structure to 300° C. may change the color of the thin-film structure from green to blue, as shown by reflectance curve 53. The maximum peak on the reflectance curve 53 is at 475 nm. Thus, the maximum peak shifts from 540 nm to 475 nm by increasing the temperature from 275° C. to 300° C.

Reflectance curves 52 and 53 in FIG. 5 illustrate how the color of the thin-film pigment structure may change with temperature. The color of the thin-film structure starts with gold, changing to shades of green as the temperature rises, and comes to an intense blue when the temperature reaches 300° C.

As indicated above, FIG. 5 is provided as an example. Other examples may differ from what is described with regard to FIG. 5.

According to the reflectance curves, FIGS. 2-5 demonstrate that thin-film pigment structures with at least one WO₃ spacer layer change color after exposure to one or more elevated temperatures. Reflectance peaks of all baked pigments with the layer structure described in connection with FIG. 1 shift in the direction of shorter wavelengths (e.g., to the left). Quick heating to a high temperature (e.g., 275-300° C.) causes fast and complete reactions (2) and (3). Heating to lower temperatures causes a pigment's color transition from the color of the unheated pigment to blue. Thus, the intensity of the coloration depends on the applied temperature and the duration of the heating time. Spacer layers with other transition metal oxides (e.g., oxides of molybdenum, europium, indium, vanadium, niobium, titanium, bismuth, or iron) may also be used to obtain different color transitions. The thin-film structures may also be designed to be initially colorless.

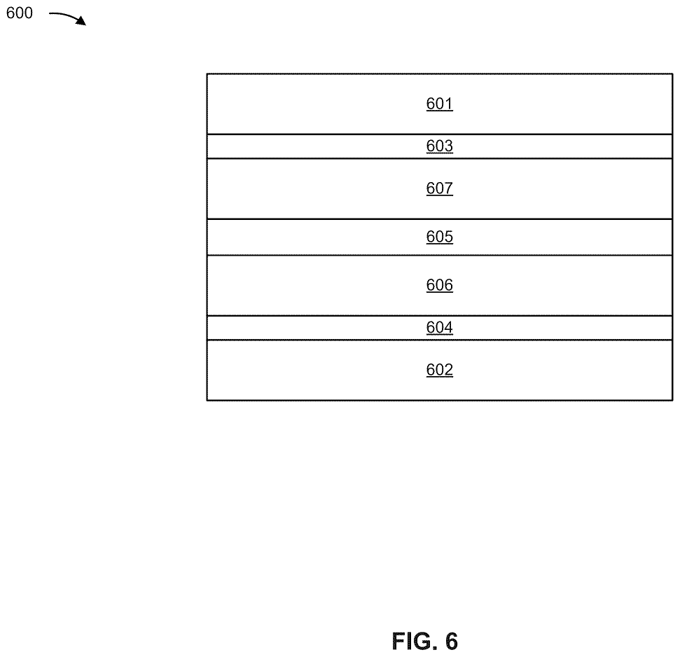

FIG. 6 shows a color-tunable pigment medium 600 according to one or more implementations. The color-tunable pigment medium 600 may be an irreversible thermochromic-effect pigment medium. The color-tunable pigment medium 600 may have a thin-film design, with a plurality of layers 601-607 arranged in a layer stack (e.g., an optical stack of thin-film layers). Tungsten trioxide here is used not as an optical spacer but rather as a blue filter on the top of a color-shifting security pigment. Heating of tungsten trioxide here changes the color of the pigment on account of combination of the pigment's color and blue color of tungsten trioxide. For example, a gold-to-green pigment with tungsten trioxide on the top changes its color after heating to green (yellow+blue=green).

While seven layers are shown, the color-tunable pigment medium 600 may have a fewer or a greater number of layers. The layer stack may include one or more transition metal oxide layers of one or more transition metal oxides. For example, layers 601 and 602 may be transition metal oxide layers. In other words, layer 601 may be a first transition metal oxide layer, and layer 602 may be a second transition metal oxide layer. Layer 601 may be a top layer of the layer stack, whereas layer 602 may be a bottom layer of the layer stack. Thus, layers 601 and 602 may be arranged as outer layers of the layer stack.

In addition, the layer stack may include one or more metal layers of at least one of aluminum or chromium. For example, layers 603, 604, and 605 may be metal layers of aluminum or chromium. In other words, layer 603 may be a first metal layer of aluminum or chromium, layer 604 may be a second metal layer of aluminum or chromium, and layer 605 may be a third metal layer of aluminum or chromium. In some implementations, the metal layers 603, 604, and 605 may be the same metal material (e.g., all metal layers may be aluminum or all metal layers may be chromium). In some implementations, the layer stack may include both aluminum and chromium. For example, metal layer 605 may be aluminum and metal layers 603 and 604 may be chromium. Accordingly, each transition metal oxide layer of the one or more transition metal oxide layers is arranged directly adjacent to a respective metal layer.

In addition, the layer stack may include one or more colorless, low-index spacer layers. For example, layers 606 and 607 may be colorless, low-index spacer layers, such as magnesium fluoride (MgF₂). Accordingly, the layer stack may have an optical structure according to the expression below:

$${WO}_{3} 150 nm / Cr 16 nm / {MgF}_{2} 197 nm / Al 80 nm / MgF 2 \; 197 nm / Cr 16 nm / {WO}_{3} 150 nm$$

The color-tunable pigment medium 600 has a color-shifting optical stack that provides a broad shift of color at a change of an observation angle.

As indicated above, FIG. 6 is provided as an example. Other examples may differ from what is described with regard to FIG. 6.

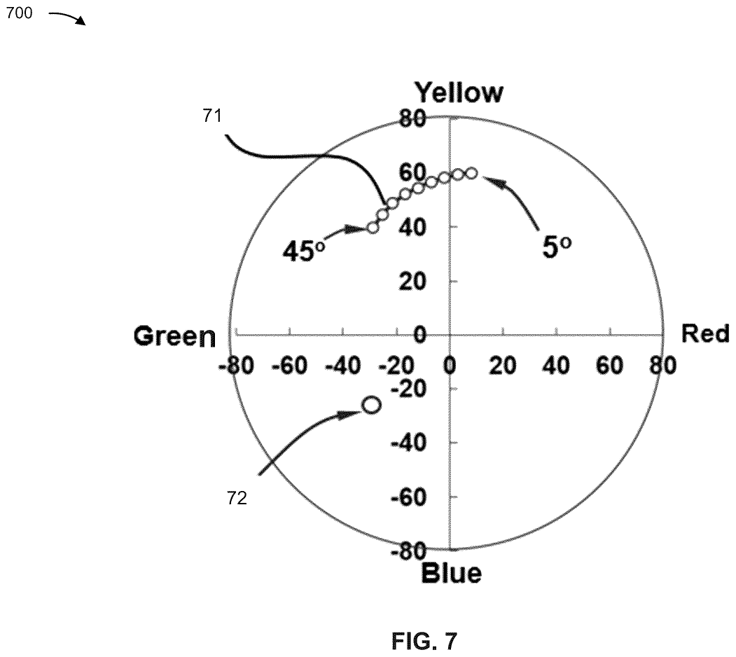

FIG. 7 shows goniochromatic color changes in a CIELab color space 700 for the color-tunable pigment medium 600. The color-tunable pigment medium 600 has an Cr/MgF₂/Al/MgF₂/Cr interference stack, with WO₃ spacer layers arranged on opposite sides of the Al/MgF₂/Cr interference stack. The color of the color-tunable pigment medium 600 (unheated) is gold-like metallic yellow at the observation angle of 5°. The color travels along curve 71 as the observation angle changes from 5° to 45°, changing from gold to green. Accordingly, the pre-heated color-tunable pigment medium 600 is goniochromatic. Heating the color-tunable pigment medium 600 to 300° C. changes the color of the color-tunable pigment medium 600 from gold to greenish-blue at the same observation angle (e.g., to position 72 in the CIELab color space 700). The color of the color-tunable pigment medium 600 (heated) depends on the WO₃ film thickness, the applied temperature, and the thermal exposure time. For example, after being in an elevated temperature state, the color-tunable pigment medium 600 (heated) may exhibit a green color with a cyan tint caused by a blending of a yellow color of an Al/MgF₂/Cr interference stack (at the normal observation angle) and a blue color of a chemically-reduced WO₃ film arranged on the Al/MgF₂/Cr interference stack. The color of the heated pigment changes with the observation angle from green with a cyan hint to intense blue.

Thus, examples of color-tunable interference pigment media are described with tungsten oxide as an active material. The examples demonstrate how insertions of the same material in different positions of the pigment structure can alter the color of the pigment. Oxides of other transition metals may cause pigment to have different color combinations. The advantage of the concept is the possibility to adjust the color of the pigment by precisely controlling the heating process both in temperature and duration of exposure.

As indicated above, FIG. 7 is provided as an example. Other examples may differ from what is described with regard to FIG. 7.

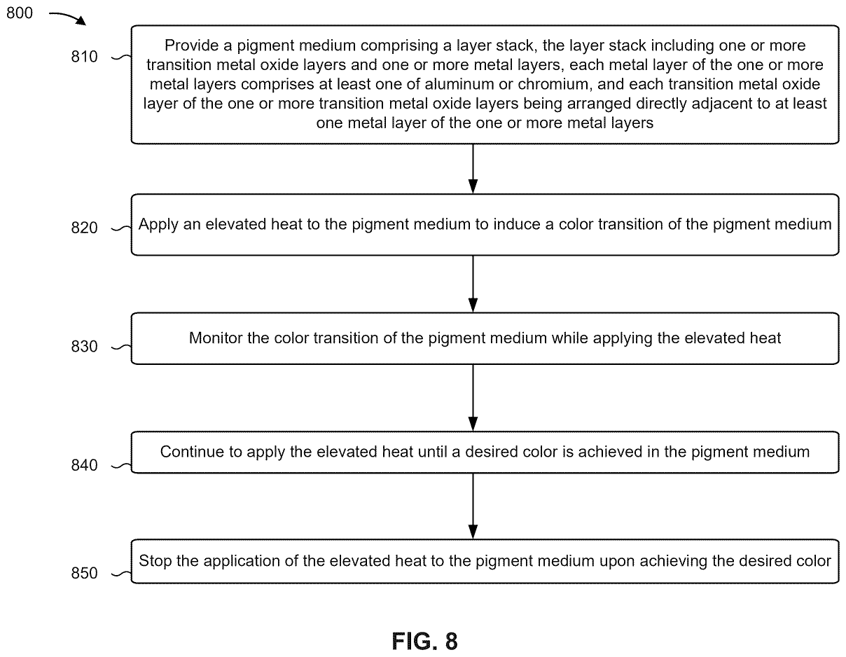

FIG. 8 is a flowchart of an example process 800 associated with a color-tunable pigment medium. For example, process 800 may be a method for fine tuning of the color of an interference pigment by heating. One or more process blocks of FIG. 8 may be performed by a heat application system and/or by another device or a group of devices separate from or including the heat application system. Additionally, or alternatively, one or more process blocks of FIG. 8 may be performed by one or more components of the heat application system, such as a processor, a controller, a heat applicator, such as a laser device or a heated stamp, a memory, an input component, an output component, and/or a communication component.

As shown in FIG. 8, process 800 includes providing a pigment medium comprising a layer stack (block 810). The layer stack includes one or more transition metal oxide layers and one or more metal layers, each metal layer of the one or more metal layers comprises at least one of aluminum or chromium, and each transition metal oxide layer of the one or more transition metal oxide layers being arranged directly adjacent to at least one metal layer of the one or more metal layers. The pigment medium may be manufactured using thin-film manufacturing equipment, configured to produce thin-film structures described above. In some implementations, the pigment medium may be applied to a printed substrate in a predetermined pattern by a conventional printing technique.

As further shown in FIG. 8, process 800 includes applying an elevated heat to the pigment medium to induce a color transition of the pigment medium (block 820). For example, a heat applicator may apply the elevated heat to the pigment medium to induce a color transition of the pigment medium, as described above. In some implementations, the heat applicator may apply the elevated heat according to a predetermined pattern.

As further shown in FIG. 8, process 800 includes monitoring the color transition of the pigment medium while applying the elevated heat (block 830). For example, a camera may be used to visually inspect and monitor the color transition of the pigment medium, and provide image feedback data.

As further shown in FIG. 8, process 800 includes continuing to apply the elevated heat until a desired color is achieved in the pigment medium (block 840). For example, a controller may be used to continue to apply the elevated heat until a desired color is achieved in the pigment medium.

As further shown in FIG. 8, process 800 includes stopping the application of the elevated heat to the pigment medium upon achieving the desired color (block 850). For example, the controller may stop the application of the elevated heat to the pigment medium upon achieving the desired color.

Process 800 may include additional aspects, such as any single aspect or any combination of aspects described below and/or in connection with one or more other processes described elsewhere herein.

In some implementations, a method for a fine tuning of colors of interference pigments by heating is provided.

In some implementations, a pigment has a pigment structure configured for a precision color tune of the pigment structure after being coated onto a medium, such as paper.

In some implementations, a thin layer of a transition metal oxide, being enclosed in the pigment structure in contact with chromium or aluminum layers chemically reacts with the chromium or aluminum layers, reducing its valent state. The color of the transition metal oxide changes from colorless to different states of blue, red, pink, or brown as a result of a redox reaction. Intensity of the resultant color of the transition metal oxide is controlled by a heating time and a temperature applied during thermal treatment. A temperature-sensitive film of an oxide may be used as a light filter in the pigment structure, thereby providing a fine color tune during thermal treatment.

In some implementations, a color-shifting interference pigment medium at the end of a fabrication process is blended with other pigments to meet a color specification. Heating the color-shifting interference pigment medium to change its color slightly might be an alternative to blending of the color-shifting interference pigment medium with the other pigments.

In some implementations, a color-tunable interference pigment includes one or more layers of one or more transition metal oxides arranged adjacent to layers of aluminum or chromium, the color-tunable interference pigment configured to undergo a color change at an elevated temperature due to a chemical redox reaction between the aluminum or chromium and the transition metal oxides, the transition metal oxides including tungsten, molybdenum, europium, indium, vanadium, niobium, titanium, bismuth, and/or iron.

In some implementations, a method of precision color tuning for interference pigments includes a steady heating of a color-tunable interference until a desired color is achieved, and immediately removing the color-tunable interference pigment from a heating zone based on the desired color being achieved.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A color-tunable pigment medium, comprising an optical stack of thin-film layers comprising: one or more transition metal oxide layers of one or more transition metal oxides; and one or more metal layers of at least one of aluminum or chromium, wherein each transition metal oxide layer of the one or more transition metal oxide layers is arranged directly adjacent to at least one metal layer of the one or more metal layers, wherein the layer stack has, in a pre-elevated temperature state, a first color, and wherein the layer stack has, in an elevated temperature state, a second color different from the first color.

Aspect 2: The color-tunable pigment medium of Aspect 1, wherein each transition metal oxide layer of the one or more transition metal oxide layers is configured to, in response to an applied external heat, transform into a respective chemically-reduced transition metal oxide.

Aspect 3: The color-tunable pigment medium of Aspect 2, wherein the applied external heat is between 100 degrees Celsius and 350 degrees Celsius.

Aspect 4: The color-tunable pigment medium of any of Aspects 1-3, wherein a color change from the first color to the second color is irreversible.

Aspect 5: The color-tunable pigment medium of any of Aspects 1-4, wherein each transition metal oxide layer of the one or more transition metal oxide layers has, in the pre-elevated temperature state, a first respective color, and wherein each transition metal oxide layer of the one or more transition metal oxide layers has, in the elevated temperature state, a second respective color different from the first respective color.

Aspect 6: The color-tunable pigment medium of any of Aspects 1-5, wherein each transition metal oxide layer of the one or more transition metal oxide layers is configured to, based on an elevated temperature being applied, undergo a respective chemical redox reaction with the at least one metal layer that is arranged directly adjacent to the transition metal oxide layer, and wherein the respective chemical redox reaction causes the transition metal oxide layer to undergo a color change.

Aspect 7: The color-tunable pigment medium of any of Aspects 1-6, wherein each transition metal oxide layer includes tungsten, molybdenum, europium, indium, vanadium, niobium, titanium, bismuth, or iron.

Aspect 8: The color-tunable pigment medium of any of Aspects 1-7, wherein the one or more transition metal oxide layers include a first layer of tungsten trioxide and a second layer of tungsten trioxide, wherein the one or more metal layers include an aluminum layer, a first chromium layer, and a second chromium layer, wherein the aluminum layer is arranged between, and in direct contact with, the first layer of tungsten trioxide and the second layer of tungsten trioxide, wherein the first layer of tungsten trioxide is arranged between, and in direct contact with, the aluminum layer and the first chromium layer, and wherein the second layer of tungsten trioxide is arranged between, and in direct contact with, the aluminum layer and the second chromium layer.

Aspect 9: The color-tunable pigment medium of any of Aspects 1-8, wherein the one or more transition metal oxide layers include a first layer of tungsten trioxide and a second layer of tungsten trioxide, wherein the one or more metal layers include a first chromium layer, a second chromium layer, and a third chromium layer, wherein the first layer of tungsten trioxide is arranged between, and in direct contact with, the first chromium layer and the second chromium layer, and wherein the second layer of tungsten trioxide is arranged between, and in direct contact with, the first chromium layer and the third chromium layer.

Aspect 10: The color-tunable pigment medium of any of Aspects 1-9, wherein the one or more transition metal oxide layers include a first layer of tungsten trioxide and a second layer of tungsten trioxide, wherein the one or more metal layers include a first aluminum layer, a second aluminum layer, and a third aluminum layer, wherein the first layer of tungsten trioxide is arranged between, and in direct contact with, the first aluminum layer and the second aluminum layer, and wherein the second layer of tungsten trioxide is arranged between, and in direct contact with, the first aluminum layer and the third aluminum layer.

Aspect 11: The color-tunable pigment medium of any of Aspects 1-10, wherein layer stack has an optical structure comprising: WO3/Cr/MgF2/Al/MgF2/Cr/WO3, wherein WO3 denotes tungsten trioxide, Cr denotes chromium, MgF2 denotes magnesium fluoride, Al denotes aluminum, and “/” denotes contact between two adjacent layers.

Aspect 12: A color-tunable interference pigment medium, comprising an optical stack of thin-film layers comprising: one or more transition metal oxide layers of one or more transition metal oxides; and one or more metal layers of at least one of aluminum or chromium, wherein each transition metal oxide layer of the one or more transition metal oxide layers is arranged directly adjacent to at least one metal layer of the one or more metal layers, wherein the layer stack, in a pre-elevated temperature state, has an obscured hue, and wherein the layer stack has, in an elevated temperature state, a visible hue different than the obscured hue.

Aspect 13: The color-tunable pigment medium of Aspect 12, wherein the obscured hue is colorless.

Aspect 14: The color-tunable pigment medium of any of Aspects 12-13, wherein each transition metal oxide layer of the one or more transition metal oxide layers is configured to, in response to an applied external heat, transform into a respective chemically-reduced transition metal oxide.

Aspect 15: The color-tunable pigment medium of any of Aspects 12-14, wherein a color change from the obscured hue to the visible hue is irreversible.

Aspect 16: The color-tunable pigment medium of any of Aspects 12-15, wherein each transition metal oxide layer of the one or more transition metal oxide layers has, in the pre-elevated temperature state, a respective obscured hue, and wherein each transition metal oxide layer of the one or more transition metal oxide layers has, in the elevated temperature state, a respective visible hue different from the respective obscured hue.

Aspect 17: The color-tunable pigment medium of any of Aspects 12-16, wherein each transition metal oxide layer of the one or more transition metal oxide layers is configured to, based on an elevated temperature being applied, undergo a respective chemical redox reaction with the at least one metal layer that is arranged directly adjacent to the transition metal oxide layer, and wherein the respective chemical redox reaction causes the transition metal oxide layer to undergo a color change.

Aspect 18: The color-tunable pigment medium of any of Aspects 12-17, wherein each transition metal oxide layer includes tungsten, molybdenum, europium, indium, vanadium, niobium, titanium, or bismuth.

Aspect 19: A method, comprising: providing a pigment medium comprising an optical stack of thin-film layers, the optical stack of thin-film layers including one or more transition metal oxide layers and one or more metal layers, each metal layer of the one or more metal layers comprises at least one of aluminum or chromium, and each transition metal oxide layer of the one or more transition metal oxide layers being arranged directly adjacent to at least one metal layer of the one or more metal layers; applying an elevated heat to the pigment medium to induce a color transition of the pigment medium; monitoring the color transition of the pigment medium while applying the elevated heat; continuing to apply the elevated heat until a desired color is achieved in the pigment medium; and stopping the application of the elevated heat to the pigment medium upon achieving the desired color.

Aspect 20: The method of Aspect 19, wherein the pigment medium is configured to, based on the application of the elevated heat, transition from an obscured hue to a visible hue.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from the practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A color-tunable pigment medium, comprising:
an optical stack of thin-film layers comprising:
one or more transition metal oxide layers of one or more transition metal oxides; and
one or more metal layers of at least one of aluminum or chromium,
wherein each transition metal oxide layer of the one or more transition metal oxide layers is arranged directly adjacent to at least one metal layer of the one or more metal layers,
wherein the layer stack has, in a pre-elevated temperature state, a first color, and
wherein the layer stack has, in an elevated temperature state, a second color different from the first color.

2. The color-tunable pigment medium of claim 1, wherein each transition metal oxide layer of the one or more transition metal oxide layers is configured to, in response to an applied external heat, transform into a respective chemically-reduced transition metal oxide.

3. The color-tunable pigment medium of claim 2, wherein the applied external heat is between 100 degrees Celsius and 350 degrees Celsius.

4. The color-tunable pigment medium of claim 1, wherein a color change from the first color to the second color is irreversible.

5. The color-tunable pigment medium of claim 1, wherein each transition metal oxide layer of the one or more transition metal oxide layers has, in the pre-elevated temperature state, a first respective color, and
wherein each transition metal oxide layer of the one or more transition metal oxide layers has, in the elevated temperature state, a second respective color different from the first respective color.

6. The color-tunable pigment medium of claim 1, wherein each transition metal oxide layer of the one or more transition metal oxide layers is configured to, based on an elevated temperature being applied, undergo a respective chemical redox reaction with the at least one metal layer that is arranged directly adjacent to the transition metal oxide layer, and
wherein the respective chemical redox reaction causes the transition metal oxide layer to undergo a color change.

7. The color-tunable pigment medium of claim 1, wherein each transition metal oxide layer includes tungsten, molybdenum, europium, indium, vanadium, niobium, titanium, bismuth, or iron.

8. The color-tunable pigment medium of claim 1, wherein the one or more transition metal oxide layers include a first layer of tungsten trioxide and a second layer of tungsten trioxide,
wherein the one or more metal layers include an aluminum layer, a first chromium layer, and a second chromium layer,
wherein the aluminum layer is arranged between, and in direct contact with, the first layer of tungsten trioxide and the second layer of tungsten trioxide,
wherein the first layer of tungsten trioxide is arranged between, and in direct contact with, the aluminum layer and the first chromium layer, and
wherein the second layer of tungsten trioxide is arranged between, and in direct contact with, the aluminum layer and the second chromium layer.

9. The color-tunable pigment medium of claim 1, wherein the one or more transition metal oxide layers include a first layer of tungsten trioxide and a second layer of tungsten trioxide,
wherein the one or more metal layers include a first chromium layer, a second chromium layer, and a third chromium layer,
wherein the first layer of tungsten trioxide is arranged between, and in direct contact with, the first chromium layer and the second chromium layer, and
wherein the second layer of tungsten trioxide is arranged between, and in direct contact with, the first chromium layer and the third chromium layer.

10. The color-tunable pigment medium of claim 1, wherein the one or more transition metal oxide layers include a first layer of tungsten trioxide and a second layer of tungsten trioxide,
wherein the one or more metal layers include a first aluminum layer, a second aluminum layer, and a third aluminum layer,
wherein the first layer of tungsten trioxide is arranged between, and in direct contact with, the first aluminum layer and the second aluminum layer, and
wherein the second layer of tungsten trioxide is arranged between, and in direct contact with, the first aluminum layer and the third aluminum layer.

11. The color-tunable pigment medium of claim 1, wherein layer stack has an optical structure comprising:
WO₃/Cr/MgF₂/Al/MgF₂/Cr/WO₃, wherein WO₃ denotes tungsten trioxide, Cr denotes chromium, MgF₂ denotes magnesium fluoride, Al denotes aluminum, and “/” denotes contact between two adjacent layers.

12. A color-tunable interference pigment medium, comprising
an optical stack of thin-film layers comprising:
one or more transition metal oxide layers of one or more transition metal oxides; and
one or more metal layers of at least one of aluminum or chromium,
wherein each transition metal oxide layer of the one or more transition metal oxide layers is arranged directly adjacent to at least one metal layer of the one or more metal layers,
wherein the layer stack, in a pre-elevated temperature state, has an obscured hue, and
wherein the layer stack has, in an elevated temperature state, a visible hue different than the obscured hue.

13. The color-tunable pigment medium of claim 12, wherein the obscured hue is colorless.

14. The color-tunable pigment medium of claim 12, wherein each transition metal oxide layer of the one or more transition metal oxide layers is configured to, in response to an applied external heat, transform into a respective chemically-reduced transition metal oxide.

15. The color-tunable pigment medium of claim 12, wherein a color change from the obscured hue to the visible hue is irreversible.

16. The color-tunable pigment medium of claim 12, wherein each transition metal oxide layer of the one or more transition metal oxide layers has, in the pre-elevated temperature state, a respective obscured hue, and
wherein each transition metal oxide layer of the one or more transition metal oxide layers has, in the elevated temperature state, a respective visible hue different from the respective obscured hue.

17. The color-tunable pigment medium of claim 12, wherein each transition metal oxide layer of the one or more transition metal oxide layers is configured to, based on an elevated temperature being applied, undergo a respective chemical redox reaction with the at least one metal layer that is arranged directly adjacent to the transition metal oxide layer, and
wherein the respective chemical redox reaction causes the transition metal oxide layer to undergo a color change.

18. The color-tunable pigment medium of claim 12, wherein each transition metal oxide layer includes tungsten, molybdenum, europium, indium, vanadium, niobium, titanium, or bismuth.

19. A method, comprising:
providing a pigment medium comprising an optical stack of thin-film layers, the optical stack of thin-film layers including one or more transition metal oxide layers and one or more metal layers, each metal layer of the one or more metal layers comprises at least one of aluminum or chromium, and each transition metal oxide layer of the one or more transition metal oxide layers being arranged directly adjacent to at least one metal layer of the one or more metal layers;
applying an elevated heat to the pigment medium to induce a color transition of the pigment medium;
monitoring the color transition of the pigment medium while applying the elevated heat;
continuing to apply the elevated heat until a desired color is achieved in the pigment medium; and
stopping the application of the elevated heat to the pigment medium upon achieving the desired color.

20. The method of claim 19, wherein the pigment medium is configured to, based on the application of the elevated heat, transition from an obscured hue to a visible hue.
